(19) United States
(12) Patent Application Publication
(10) Pub. No.: US 2017/0175928 A1
(43) Pub. Date: Jun. 22, 2017

(54) BALL VALVE

(71) Applicant: HYDAC ACCESSORIES GMBH, Sulzbach/Saar (DE)

(72) Inventor: Pascal MEIER, Neunkirchen (DE)

(21) Appl. No.: 15/116,261

(22) PCT Filed: Feb. 7, 2015
(86) PCT No.: PCT/EP2015/000254

§ 371 Date: Aug. 3, 2016

(30) Foreign Application Priority Data
Feb. 28, 2014 (DE) 10 2014 002 917.4

(51) Int. Cl. F16K 37/00; F16K 27/06; F16K 31/06; F16K 5/06

(52) U.S. Cl. CPC F16K 37/0041; F16K 5/0647; F16K 27/067; F16K 31/06

(57) ABSTRACT

Disclosed is a ball valve comprising a valve housing (2) that includes at least two fluid connection points (12, 14) and a valve ball (26) which is located in the valve housing (2) and which can be rotatingly actuated into switched positions by means of a switching shaft (32), at least part of which engages into the valve housing (2), a fluid connection between fluid connection points (12, 14) being opened or closed via a fluid passage (30) in the valve ball (26) in the switched positions of the valve ball (26). The disclosed ball valve is characterized in that a sensor array (52, 54) identifies each switched position of the valve ball (26) by reading positional information (48, 50) located thereon.

The invention relates to a ball valve, comprising a valve housing that has at least two fluid connection points and a valve ball that is located in the valve housing and that can be rotatingly actuated into switched positions by means of a switching shaft, at least part of which engages in the valve housing, in which switched positions a fluid connection between fluid connection points can be opened or closed via a fluid passage in the ball valve.

In the prior art, ball valves are used mostly as shut-off devices in diverse fluid systems, although they can also be used as bleed valves or for other functions. As a rule washers or sealing shells made of plastic such as PTFE are installed between the valve ball forming the shut-off device and the valve housing, and at higher operating temperatures use can also be made of metal gaskets. Ball valves are distinguished by a good seal owing to the contact forces between the valve ball and the washers as well as between the latter and the valve housing, which contact forces are enhanced by the fluid pressure. Another advantage is the rapid switching action. With a straight fluid passage located in the valve ball, a complete closing is brought about within a precisely 90° turn of the valve ball, which enables shorter actuation times compared to shut-off valves of other designs. Also, very small flow losses occur in the open state with a cross section of the fluid passage of the valve ball that corresponds to the cross section of the line at the connection points.

Ball valves are actuated manually by means of a pivot lever engaging on the switching shaft. As an alternative, provision can be made for an automatic actuation; for example, provision can be made of a motorized actuator in places that are difficult to reach by hand. For the rotating movement of the switching shaft over the angular range of 90° between the closed position and the open position, a cam disc forming a kind of backstop with the end stops delimiting the 90° range is typically provided on the extension of the switching shaft protruding from the housing, which end stops cooperate with an associated stop pin on the valve housing. During operation, the checking of the respective switched position of the valve ball i.e., the checking of the turning position of the switching shaft with the cam mounted thereon relative to the stop pin of the housing, is effected via the switching shaft. In many cases this type of state monitoring, which is also visual, is not satisfactory and in particular is inadequate if such a ball valve is used for safety-relevant switching functions. With a check made by means of the switching shaft, the actual switching position of the ball cannot be established. The ball position cannot be accurately checked if the switching shaft breaks or if the mechanical coupling of the ball with the switching shaft fails.

With regard to these problems, the object of the invention is that of providing a ball valve that enables an accurate checking of the ball position.

According to the invention, this object is achieved with a ball valve that has the features of claim 1 in its entirety.

According to the characterizing part of claim 1, an essential special feature of the invention lies in the fact that provision is made of a sensor array, which identifies the respective switched position of the valve ball by reading positional information located thereon. The fact that the switched position is not indicated by means of the switching shaft enables a totally accurate indication of the actual switched position. Errors that can occur in the prior art due to, for instance, failure of the switching shaft or of its coupling to the valve ball, or malfunctioning of an actuator for the switching shaft, are thus avoidable so that the ball valve according to the invention is also suitable for use in systems on which high safety requirements are placed.

In a particularly advantageous fashion, provision can be made of a sensor array for the contactless reading of the positional information. To this end, use can be made of known prior art sensor systems such as laser optic systems, inductive systems, or the like. As an alternative, a system can be provided for the mechanical scanning of physical positional markings on the valve ball.

In particularly advantageous exemplary embodiments, the positional information is formed by a pattern of a plurality of positional markings located on the valve ball, wherein the sensor array has at least one positional marking identifying sensor associated with the valve housing. With a plurality of positional markings, indications for the completely opened position as well as for the closed position of the valve ball can be generated.

For a ball valve in which the valve ball has a fluid passage running orthogonally to the axis of rotation of the switching shaft, two positional markings can be provided as positional information, which are each arranged offset relative to the axis of rotation. If the sensor array in this case has two sensors inserted in the valve housing, it is not only possible to generate an indication of the open position and of the closed position, but also an unambiguous indication that the valve ball is in an undefined intermediate position.

In a particularly advantageous fashion, the sensors can be arranged spaced apart from one another along a straight line that intersects the axis of rotation of the switching shaft and extends perpendicular to the direction of the valve ball fluid passage in the open position.

As suitable positional markers for different scanning techniques of the sensor array that can be easily formed on the valve ball, provision can be made of recesses, preferably in the form of blind holes, in the outer surface of the valve ball.

For a particularly advantageous contactless scanning, provision can be made of a valve ball made of a material with ferromagnetic properties, wherein for generating a switch signal, inductive sensors are provided as sensors that identify the position of a blind hole of the valve ball aligned with a sensor. A switch signal designating the exact position of the valve ball can thus be generated in a very accurate manner on the basis of the change in inductivity, which arises when a blind hole reaches a position aligned precisely to the core or detector element of a proximity switch.

In advantageous exemplary embodiments, the sensors are incorporated as inserts, preferably by screwing, in through-bores of the valve housing, wherein sealing surfaces for a pressure resistant seal-forming sealing element are formed in the through-bores and on the inserts. The valve housing is thus also sealed against pressure building up in the clearance volume between the ball surface and the valve housing.

The invention is explained in detail in the following, with reference to an exemplary embodiment illustrated in the drawings. Therein:

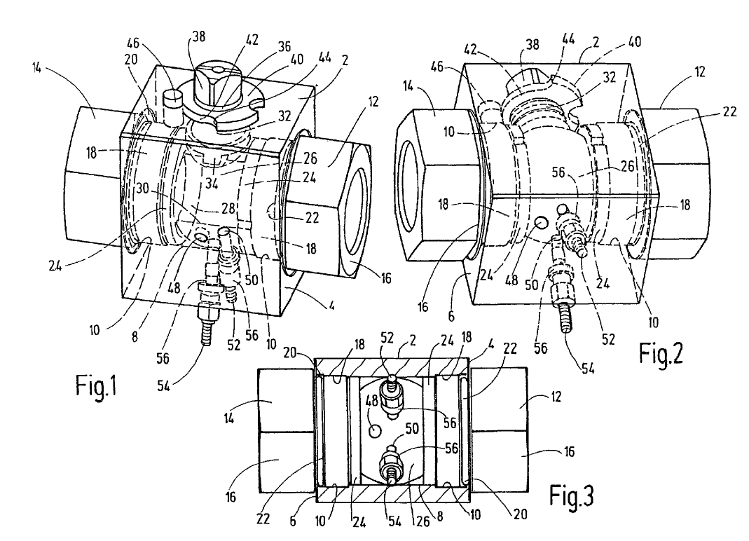

FIGS. 1 and 2 show perspective diagonal views with a transparently drawn valve housing, seen from different viewing directions, in which the open switched position is illustrated;

FIG. 3 shows a view from below of the open switched position, with the valve housing cut away;

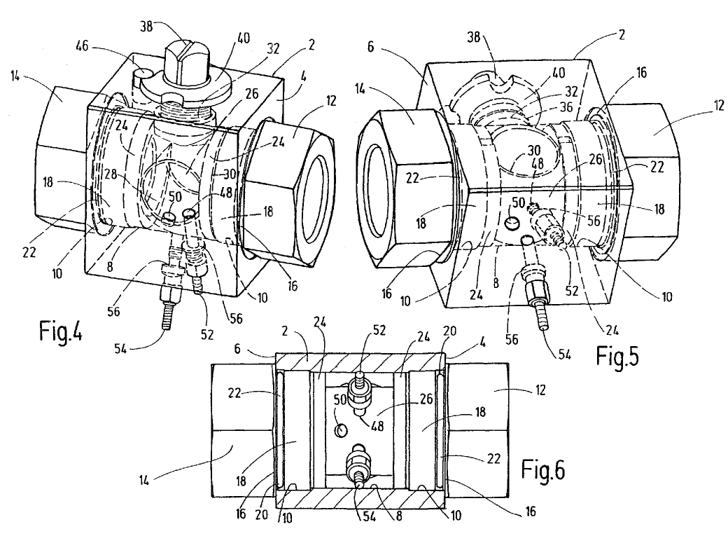

FIGS. 4-6 show illustrations corresponding to FIGS. 1 through 3, in which the closed switched position is illustrated in each case;

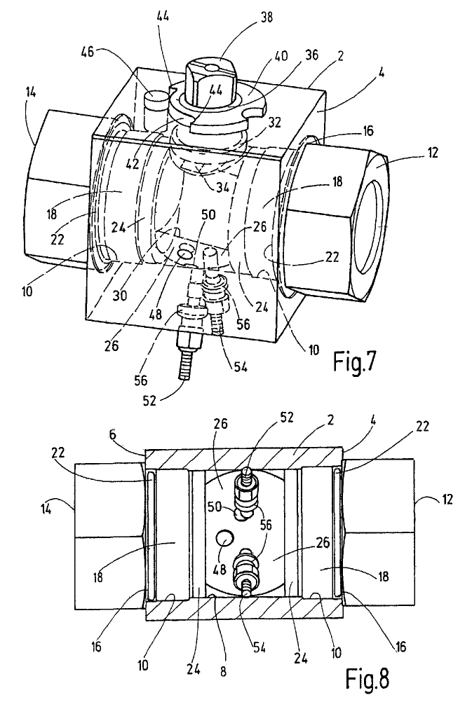

FIGS. 7 and 8 show illustrations similar to FIGS. 1 and 4, in which a switched position corresponding to an intermediate position is shown;

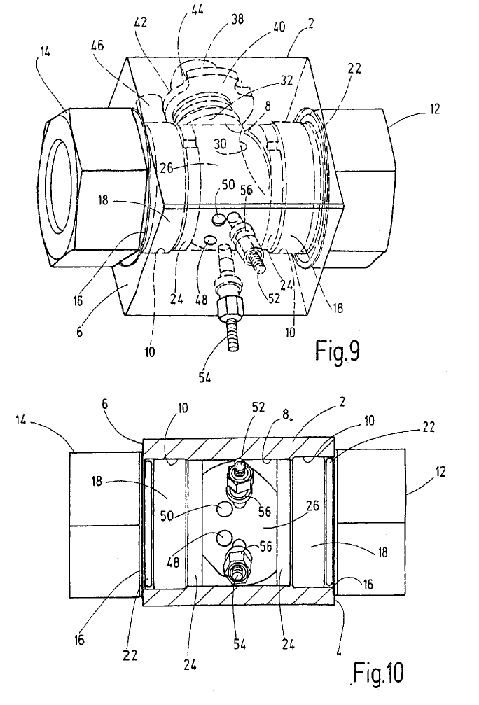

FIGS. 9 and 10 show illustrations corresponding to FIGS. 7 and 8, in which a switched position corresponding to a second intermediate position is shown, and

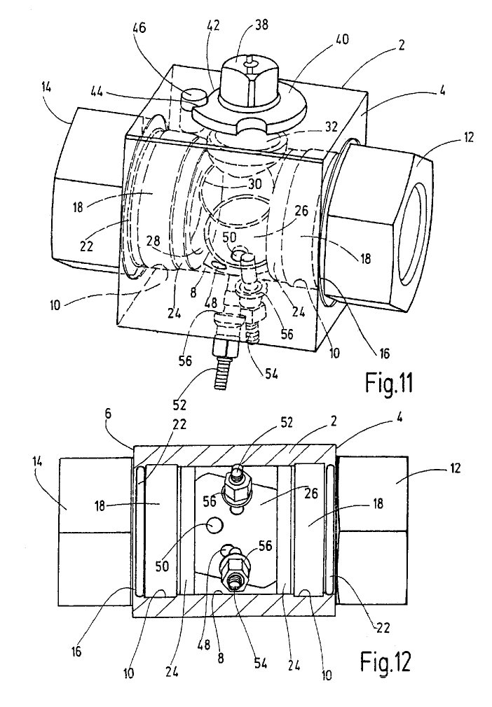

FIGS. 11 and 12 show illustrations corresponding to FIGS. 9 and 10 of a switched position corresponding to a third intermediate position.

The ball valve illustrated in the figures has a valve housing 2 in the shape of a cube made of a metal material, for example a red brass suitable for fittings. A through hole 8 is formed, centrally located, between opposite side walls 4 and 6, which has a female thread 10 on each of its end regions adjoining the side wall 4 and the side wall 6. For forming each connection point, connecting parts 12 and 14 for lines not shown in any further detail are screwed in with the female threads 10. Between the outer hex head 16 and the male thread section 18 screwed in with the female thread 10, the connecting parts 12, 14 each have a radial groove 20 for an O-ring 22, which forms the seal at each fluid connection point.

On the end of the male thread section 18 of the connecting parts 12, 14, a PTFE ring gasket 24 forms a type of soft seal for a valve ball 26 incorporated between the ring gaskets 24. The ring gaskets 24 thus form sealing shells 28 (see FIG. 1) adapted to the spherical shape of the valve ball 26 for the valve ball 26 floatingly mounted thereon. As a fluid passage, this valve ball has a bore 30 that has the same diameter as the passage cross section of the connecting parts 12, 14 of the fluid connection points. In the position of the valve ball 26 shown in FIGS. 1-3, in which its bore 30 aligns with the connecting parts 12, 14 and the ball valve is in the open state, the full cross section of the fluid flow is maintained over the ball valve so that there are practically no flow losses.

For adjusting the rotational position of the valve ball 26, provision is made of a switching shaft 32, which is connected via a coupling part 34 to rotate with the valve ball 26 and which with a shaft extension 36 protrudes above the top side of the valve housing 2, which is visible from above in FIG. 1. The shaft extension 26 [sic] has a square head 38 for engaging an actuator element such as a (not illustrated) hand lever. A cam disc 40 is connected to rotate with the shaft extension 36, which on its perimeter forms a curved path 42 that extends over a 90° angular range and forms an ends stop 44 at both ends which, in cooperation with a stop pin 46 that protrudes from the top side of the valve housing 2, limits the rotation of the switching shaft 32 to a 90° rotation angle.

For a sensor array that queries the switched position of the valve ball 26 directly on the latter, the ball valve according to the invention has positional markings provided on the outer surface of the valve ball 26, which are formed by blind holes 48 and 50. The blind holes 48, 50 are formed in a pattern arrangement in the surface of the valve ball 26 in such a way that each blind hole 48, 50 is offset relative to the axis of rotation of the switching shaft 32. The valve ball 26 is made of a material with ferromagnetic properties and the sensor array, which is provided for reading the positional information of the ball 26 formed by the blind holes 48, 50, has two inductive proximity switches 52 and 54 as sensors. These are introduced as screw inserts into bores from the bottom side of the valve housing 2, which is opposite the shaft extension 36 of the switching shaft 32, in such a way that they extend as far as the bore 8 of the valve housing 2.

As is most readily discernible in FIG. 3, the proximity switches 52, 54 are arranged spaced apart from one another along a straight line, which intersects the axis of rotation of the switching shaft 32 and extends perpendicular to the direction of the bore 30 of the valve ball 26 in the open position. The proximity switches 52, 54 screwed into the associated through-bores have a sealing surface-forming flange 56 in order to form, by means of a (not visible) sealing element, a seal with a sealing surface in the associated bore so that the clearance volume in the valve housing 2 between the bore 8 and the outer surface of the ball 26 is sealed off in a pressure resistant manner. With their core or sensor ends, the proximity switches 52, 54 extend up to the very surface of the ball 26.

As a result of the ferromagnetic property of the valve ball 26, a change in inductivity is induced if a blind hole 48 or 50 comes into alignment with a sensor end of a proximity switch 52 or 54 during a rotating movement of the ball 26. When it is precisely aligned with a blind hole 48, 50, the proximity switch 52 or 50 in question generates a switch signal. In the open switched position of the ball valve as shown in FIGS. 1-3, the proximity switch 54 generates a switch signal by aligning with the blind hole 50, whereas the proximity switch 52, which is located outside the zone of a blind hole 48, 50, does not generate any switch signal. The sensor array thus provides an unambiguous indication that the valve ball 26 is in the open switched position.

FIGS. 4-6 show the switched position with the ball valve closed. As is most clearly discernible in FIG. 6, the blind hole 48 is in alignment with the proximity switch 52 so that the latter generates the switch signal, whereas the proximity switch 54 is outside the zone of a blind hole 48 or 50 and does not generate any switch signal. It is thus unambiguously indicated that the ball valve is closed. As illustrated in FIG. 6, both sensors 52, 54 lie jointly in a vertical plane, which extends perpendicular to the possible flow through direction of the ball valve in its fully open position. Furthermore, the imaginary extensions of the longitudinal axes of the two sensors 52, 54, looking towards the valve ball 26, form an acute angle with each other. Whereas the sensor 52 is in a position coinciding with the marker or marking 48, the other marker or marking 50, is arranged to the left (when facing FIG. 6) of the two sensors 50, 52 and forms, with the ends of the respective imaginary axis extension, an imaginary right and spherical triangle more or less on the valve ball 26 itself, said triangle having the marker position 50 arranged on the valve ball 26 in the left-hand free triangle point. Within the imaginary spherical triangle, the leg length between the marker 50 and the respective sensor 52, 54 is less, preferably around ⅔ as long as the leg length between the sensors 52, 54 themselves.

FIGS. 7 and 8 on the other hand show an intermediate position of the valve ball 26, in which the bore 30 forming the fluid passage of the valve ball 26 in FIG. 7 runs slightly diagonally downwards from the left to the right. Both blind holes 48 and 50 are out of alignment with a proximity sensor 52, 54, hence no switch signal is generated. Lacking signal generation unambiguously indicates that the switched position of the valve ball 26 is undefined.

FIGS. 9 and 10 as well as FIGS. 11 and 12 illustrate two other different undefined intermediate positions of the valve ball 26, in which once again neither of the proximity switches 52, 54 is generating a switch signal because both blind holes 48 and 50 are out of alignment with a proximity switch 52, 54. In the example of FIGS. 9 and 10, the valve ball 26 is positioned diagonally such as to give rise to around a quarter of the full opening cross section. As is most clearly discernible in FIG. 10, both blind holes 48, 50 are outside the zone of the proximity switches 52, 54 such that neither one is generating a switch signal. In the other example of FIGS. 11 and 12, the ball valve is almost completely closed. In this undefined intermediate position, once again neither of the proximity switches 52, 54 is generating a switch signal because both blind holes 48, 50 are out of alignment with a proximity switch 52, 54.

Since the switch signals are generated as digital on-off signals, the sensor array is suitable for a digital PLC. The sequence of signals for the open switched position, closed switched position, and undefined switched position for a ball valve with a straight fluid passage (bore 30) is listed in the following truth table. With a ball valve configured as a 3-way fitting with an L-shaped passage of the valve ball and a 90° turning range of the switching shaft, as exemplified in DE 299 06 687 U1, the stop position check can be implemented in accordance therewith if at least two proximity switches and three blind holes are provided on the valve ball.

Truth Table

| | Sensor 52 | Sensor 54 |
|---|---|---|
| Open switched position | 0 | 1 |
| Closed switched position | 1 | 0 |
| Undefined switched position | 0 | 0 |

For a 3-way fitting with a T-shaped passage of the valve ball and a 180° turning range of the switching shaft, the stop position check can be implemented accordingly if at least three proximity switches and at least two blind holes are provided on the valve ball. The truth table would then have to be expanded by one line and one column. Accordingly, this enables the generation of the signal sequence 0 1 0 for the first open switched position, the signal sequence 1 0 0 for the second open switched position, the signal sequence 1 0 1 for the third open switched position, and the signal sequence 0 0 0 for the undefined switched position.

Obviously the signals can also be inverse, in other words a 0 can be used instead of a 1 and a 1 can be used instead of a 0. The unambiguity of the signal sequence will still be maintained.

1. A ball valve, comprising a valve housing (2) that has at least two fluid connection points (12, 14) and a valve ball (26) located in the valve housing (2), which valve ball can be rotatingly actuated into switched positions by means of a switching shaft (32), at least part of which engages in the valve housing (2), in which switched positions a fluid connection between fluid connection points (12, 14) is opened or closed via a fluid passage (30) of the valve ball (26), characterized in that a sensor array (52, 54) is provided, which identifies the respective switched position of the valve ball (26) by reading positional information (48, 50) located thereon.

2. The ball valve according to claim 1, characterized in that provision is made of a sensor array (52, 54) for the contactless scanning of the positional information (48, 50).

3. The ball valve according to claim 1, characterized in that the positional information is formed by a pattern of a plurality of positional markings (48, 50) located on the valve ball (26) and that the sensor array has at least one sensor (52, 54) associated with the valve housing (2) that identifies the positional markings (48, 50).

4. The ball valve according to claim 1, characterized in that the valve ball (26) has a fluid passage (30) running orthogonally to the axis of rotation (36) of the switching shaft (32) and two positional markings (48, 50) as positional information, which are each arranged offset relative to the axis of rotation (36).

5. The ball valve according to claim 1, characterized in that the sensor array has two sensors (52, 54) inserted in the valve housing (2).

6. The ball valve according to claim 1, characterized in that the sensors (52, 54) are arranged spaced apart from each other along a straight line, which intersects the axis of rotation (36) of the switching shaft (32) and extends perpendicular to the direction of the valve ball (26) fluid passage (30) in the open position.

7. The ball valve according to claim 1, characterized in that recesses, preferably in the form of blind holes (48, 50), are provided as positional markings in the outer surface of the valve ball (26).

8. The ball valve according to claim 1, characterized in that the valve ball (26) possesses ferromagnetic properties and that inductive proximity switches (52, 54) are provided as sensors, which identify the position of a blind hole (48, 50) of the valve ball (26) that is aligned with a sensor (52, 54) for generating a switch signal.

9. The ball valve according to claim 1, characterized in that the sensors are incorporated as inserts, preferably by screwing, in through-bores of the valve housing (2) and that sealing surfaces (56) for a pressure resistant seal-forming sealing element are formed in the through-bores and on the inserts.
